(19) United States
(12) Patent Application Publication
(10) Pub. No.: US 2024/0005318 A1
(43) Pub. Date: Jan. 4, 2024

(54) RESOURCE MODELING, ACCESS, AND SECURITY

(71) Applicant: NCR Corporation, Atlanta, GA (US)

(72) Inventor: Robert Michael Dolezal, Buford, GA (US)

(21) Appl. No.: 17/855,303

(22) Filed: Jun. 30, 2022

(51) Int. Cl. G06Q 20/40; H04L 9/40; G06Q 20/02

(52) U.S. Cl. CPC G06Q 20/401; H04L 63/20; H04L 63/10; G06Q 20/023

(57) ABSTRACT

Account-based resource management is provided. A resource is modeled within a resource data model. Attributes on fields of the data model are custom set by an owner who controls the resource. Access rules are assigned based on the attributes set on the fields. The corresponding rules associated with a given access request on the resource are enforced to ensure proper security during the access request. In an embodiment, a service is provided that performs a workflow for a given type of access request on behalf of the owner and at least one other party that is requesting access to the resource.

### BACKGROUND

Nearly every enterprise that provides a service of some kind to its consumers provides the access to the service based on accounts. Consumers cannot gain access without first establishing an account for access to the services (even for free services). This was true before omnipresent device connectivity, before online service availability, and still today.

Fundamentally, access to an account and availability of different aspects of a corresponding service are remarkably constrained by common, long-standing, and accepted core features associated with a data model for the account and long-established beliefs about how the account is accessed through the service. This universally accepted data model has driven the features and capabilities provided by the services within the industry.

For example, a consumer likely holds a single and uniquely identifiable account within an enterprise, limited linkage capabilities to other external accounts/internal accounts of the enterprise, and predefined rules that govern how the services of the enterprise or external services can access and use the account. This made sense before the digital age since it would have been extremely cumbersome to change these restrictions and it generically reflected how services were provided or operated. However, these same notions have persisted even with advancement in technologies.

In fact, services, which require access to the accounts, are provided based on these outdated and accepted practices. For example, a financial account of a payer typically requires the payer to share account information with a payee, a practice that is associated with many known security risks. Technologies have been developed to minimize the risk but not to change the process entirely or to remove the risk completely. Further, even with these technologies, consumers are still faced with situations where the technology is not available, such as paying for a meal at a restaurant where the consumer has to relinquish control of a credit card to a waiter for payment.

### SUMMARY

In various embodiments, methods and a system for resource modeling, access, and security are presented. A data model is derived/defined for a resource, and attributes for fields of the data model are custom-selected or customer-set by a resource owner/user through an interface. The resource may be accessed using one or more aliases defined by the owner; each alias includes its own set of attributes. Access to any given alias is provided through a specific portal. Each portal enforces access restrictions using custom-rules associated with the corresponding attributes of the corresponding alias.

According to an aspect, a method for resource modeling, access, and security processing is presented. A data model for a resource is obtained and attributes are received for fields of the data model. The attributes are customer-selected or customer-set by an owner associated with the resource. Access rules for the resource are assigned based on the attributes and the access rules are enforced during access to the resource.

### BRIEF DESCRIPTION OF THE DRAWINGS

FIG. 1 is a diagram of a system for resource modeling, access, and security processing, according to an example embodiment.

FIG. 2A is a diagram of a method for resource modeling, access, and security processing, according to an example embodiment.

FIG. 2B is a diagram of embodiments for the method of FIG. 2A.

FIG. 2C is a diagram of additional embodiments for the method of FIG. 2A.

FIG. 3A is a diagram of another method for resource modeling, access, and security processing, according to an example embodiment.

FIG. 3B is a diagram of embodiments for the method of FIG. 3A.

### DETAILED DESCRIPTION

Availability of services and the workflow of the services are also constrained by what capabilities are available through the data model associated with an account. A conventional account data model is identified through a single set of account-identifying data and a common global set of attributes that determine access and capabilities of the account. For example, a credit or debit card account has an account number, owner name, expiration date, credit limit, billing zip code, card verification value (CVV), and issuing institution. A data model for a checking account is universally defined by an account number, current balance, routing number to the financial institution, and owner name(s). Any transaction-based service (or even a consumer owner of an account) that requires access to the account must use and is constrained by these attributes on the data model for the account, such that features of the service and the workflow of the service (or consumer deposit or withdrawal) are dictated by these data models, allowed operations, and corresponding attributes. Again, since these data models, operations, and attributes are known by everyone, thieves can use nefarious services or workflows to obtain the account numbers and steal from the accounts with much greater ease than would be the case if the attributes and rules for accessing capabilities were not universally known and/or were custom-defined.

Additionally, it is not just financial institution accounts that suffer from these flaws associated with common data models, common attributes, and common capabilities. Information today can be more valuable than currency. Services hold a vast array of confidential information about their customers, and hackers are continuously trying new ways to penetrate enterprise security and obtain this confidential information. The information obtained can be used in a wide array of manners, such as unauthorized marking to the customer, stealing the identity of the customer, selling the information, and/or bribing the customer and/or the enterprise.

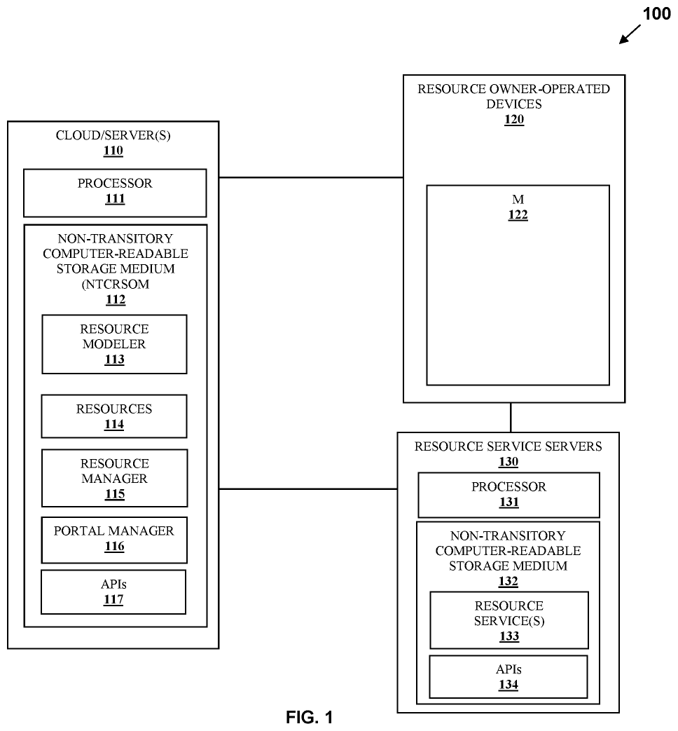

FIG. 1 is a diagram of a system 100 for resource modeling, access, and security processing, according to an example embodiment. It is to be noted that the components are shown schematically in greatly simplified form, with only those components relevant to understanding of the embodiments being illustrated. Furthermore, the various components (that are identified in the FIG. 1) are illustrated and the arrangement of the components is presented for purposes of illustration only. It is to be noted that other arrangements with more or fewer components are possible without departing from the teachings of resource modeling, access, and security, presented herein and below.

System 100 provides a flexible data model for a resource, attributes of the resource, and customizable rules defining access to the resource. The data model permits a configurable number of aliases for access to the resource, and each alias provides constrained portal-based access for a set of functions, purposes, and/or capabilities associated with the corresponding alias. Each portal-based access enforces its own set of customized rules based on the corresponding functions, purposes, and/or capabilities. A stated purpose for a portal defines or is associated a set of functions and capabilities (operations) available for the stated purposes. The resource includes global private-access only attributes with alias-specific customizable attributes for each alias. The customizable attributes permit new workflows and new services for performing customized access to the resource via the portals associated with the customized rules.

As used herein a “resource” is a data or information asset represented in a data model. The “data model” is a data structure that defines fields of the resource, global attributes, global access operations (access capabilities or functions), global access rules, per-portal or per-alias attributes, per-portal or per-alias operations, and per-portal or per-alias access rules. An “instance of the data model” refers to a given data model whose fields are populated with owner-specific data values.

A “service” is one or more sets of cooperating executable instructions that perform transactions between two or more parties using one or more resources. A “transaction” refers to access of one or more of the resources to obtain or to update data values for an instance of the data model (or multiple data model instances) using the portal-specific attributes constrained by the portal-specific access rules. Access to the resource can be to obtain data values (with no changes) or to update data values associated with one or more fields of one or more data model instances. For example, a financial service performs a financial transaction on behalf of a payer to pay a payee in a financial transaction. The financial service accesses the financial account (financial resource) of the payer to transfer funds to a financial account (financial resource) of the payee.

An “owner” refers to an individual or other entity (e.g., enterprise) that controls the resources. This may be a consumer or an enterprise such as a retailer, a government agency, or a non-profit/profit-based organization. As used herein, the terms “user,” “owner,” and/or “holder” may be used interchangeably and synonymously. This refers to an individual that is operating a device through an interface to interact with a cloud environment 110 during a creation or a modification of a resource or during a transaction associated with the resource.

The operations of the system 100 are discussed within a context of a financial account (one type of resource) and a financial service, but it is to be understood that the type of resource and the type of service may include many different types, such as a social media account associated with a social media service, an entertainment account associated with an entertainment service, a retailer or travel-based account associated with a retailer or travel-based service, or any other service-based account and corresponding service-based account service that collects, retains, and/or performs transactions on information associated with a user of that service.

In an embodiment, the flexible data model represents a financial account (financial resource) data structure (as discussed above). The global attributes may include fields associated with a master account number or identifier, an owner name, an issuing entity, one or more current balances, an account history of transactions for both global and per-portal (per-alias) attributes, and capabilities (e.g., operation identifiers) for creating, editing, and deleting a portal (alias) of the financial account. Each portal or alias for access to the account is further defined within the data structure with per-portal attributes that include a portal identifier (account alias), text description of the portal, public/private characterization (owner-defined purpose—limits capabilities assigned to the portal), operational capabilities, enabled/disabled status, and a schedule of enablement (supports temporary aliases/portals and periodically enabled aliases/portals).

Continuing with the previous embodiment, operational capabilities for any given portal are further defined within the data model with attributes associated with receiving payments, transmitting payments, receiving invoices, issuing invoices, checking current balances of the account, checking transaction history, allowing credit checks, currency limits (per payment per transaction, per payment per month, and maximum cumulative payments disbursed), maximum number of payment transactions, allowed frequency of transactions (such as once per month, etc.), allowed or disallowed interaction with other accounts for transactions, triggers for notification of activity, communication channels for the notification of activity (such as text message, email, etc.), and deferred disbursement of funds (for example, to authorize payments after receiving handshaking confirmation of a payee).

Referring now in more detail to FIG. 1, system 100 includes at least one cloud environment 110 (which may include one or more remotely located servers), resource owner-operated devices 120, and resource service servers 130. It is to be noted that more components or fewer components may be present, such that the configuration illustrated in FIG. 1 is one embodiment of system 100.

Cloud/server 110 includes at least one processor 111 and a non-transitory computer-readable storage medium 112. Medium 112 includes a resource modeler 113, resource manager 115, portal manager 116, and application programming interfaces (APIs) 117, each of which includes executable instructions, that when executed by processor 111, cause processor 111 to perform respective corresponding operations discussed herein and below with respect to 113 and 115-117. Medium 112 also includes data structures for resources 114.

Each owner-operated device 120 (herein after just “owner device 120”) includes at least one processor 121 and a non-transitory computer-readable storage medium 122. Medium 122 includes resource access interface 123 and one or more resource service interfaces 124 each of which includes executable instructions that when executed by processor 121, cause processor 121 to perform respective corresponding operations discussed herein and below with respect to 123-124.

Each resource service server 130 includes at least one processor 131 and a non-transitory computer-readable storage medium 132. Medium 132 includes one or more resource services 133 and APIs 134, each of which includes executable instructions that when executed by processor 131, cause processor 131 to perform respective corresponding operations discussed herein and below with respect to 133-134.

Resource modeler 113 creates and modifies the financial accounts (resources 114) of account owners through interaction with the owners via resource access interfaces 123 of owner-operated devices 123. Resource access interface 123 presents options to the owner to define aliases for the owner's financial account 114. In an alternative embodiment, an owner may be required to obtain assistance for alias creation and other operations. Each alias defines specific portal-based accesses to the financial account. Each alias is managed by resource manager 115 from the corresponding portal-based attributes in the data model as an independent account (resource 114) defined and controlled by rules driven by the values set on the portal-based attributes.

For example, an alias defined via the per-portal attributes in the data model for the financial account 114 may include an attribute value set by the owner on the public/private characterization attribute that limits the alias to only receiving funds or payments. This may, in turn, cause resource manager 115 to assign access rules that only permit deposits of funds into the financial account when the service 133 attempts to access the account using the attribute value set for the portal identifier (portal/alias identifier). Similarly, other attribute values set by the owner on the portal/alias through interface 124 using modeler 113 may cause resource manager 115 to link and associate other predefined access and management rules.

It is noted that in the example introduced above, the owner never has to share anything other than the portal identifier for purposes of receiving funds into their financial account 114. Thus, the owner can be assured that sharing the portal identifier does not pose any security risks to the owner's financial account 114 because portal manager 116 enforces access rules that permit only deposit of funds by any given service 133. The portal identifier, without more information, does not provide a hacker any means to link the portal identifier back to the attribute value associated with the master account identifier for the financial account 114. Security of the financial account 114 is controlled by the owner since the owner need only provide the public-facing portal identifier attribute value to individuals or services 130 when the owner is expecting a payment to be made to the owner.

Portal manager 116 enforces rules set by resource manager 115 during access requests made by a service 133 through APIs 134 and 117. Portal manager 116 identifies the portal identifier (alias identifier) made in an access request by service 133 and obtains the corresponding access rules for the corresponding resource 114 through resource manager 115 using the portal identifier. Portal manager 116 ensures that any requested access operation made with the request by service 133 is constrained by the set of rules set on the portal-attribute values.

In an embodiment, any given operation or set of operations for 110, 120, and 130 may entail manual operations that are performed by a user through an interface. In this way, 110, 120, and 130 may include interfaces that permit a user to manually perform a given operation or set of operations.

A variety of operational embodiments of system 100 are now provided for purposes of illustrating various processing workflows capable of being performed by system 100. It is noted that the illustrated embodiments are not exclusive, meaning that any combination of embodiments may be simultaneously provided by system 100.

In an embodiment, each portal defined in the data model via the corresponding set of portal attributes for the resource 114 represents its own set of unique access rules differentiated by purpose, function, currency denomination, and accessibility. The unique access rules are assigned by resource manager 115 based on the corresponding portal-based attribute values set by the owner via interface 124. For example, one alias (portal identifier value) may be used for receiving payments only and freely provided with no concern of security to those individuals or entities that are paying the owner. Another alias may set specific limits on the amount of currency that can be disbursed per month or even the frequency of disbursements (e.g., to pay utility bills, etc.). Other aliases may have specialized purposes, such as authorizing credit checks of the owner (such that no deposits or withdrawals are permitted, and the alias may be configured to expire after a credit check is performed or after a specified amount of time elapses).

The enabled duration of service 133 access to the aliases (defined by the owner) can be temporary, single use, limited in frequency during an owner-defined time period, limited to a set number of accesses, limited to a specific owner-defined service 133 or owner-defined collection of services 130, prohibited with respect to an owner-defined service 133 or owner-defined collection of services 130, removed based on an event, and/or ongoing until removed by the owner.

In an embodiment, instead of associating a single pool of currency from a single financial account 114, multiple pools of currency from the single account can be differentiated by currency, purpose, function, capability, and access. For example, an owner may segment a financial account 114 into portions reserved for paying recurring monthly bills or providing fund transfers using an alias defined by the values set on the portal-based attributes. An alias may be defined with segmented funds from the financial account 114 by the owner and reserved for goals of the owner, such as travel, education, medical, car, home improvement, etc. A segmented portion of the funds from the financial account is accessed and operates as a fully separate and functional account via the corresponding portal identifier.

In an embodiment, instead of mandating a same level of access for all owners of an account, system 100 provides custom-assigned and definable levels of access tailored to the owners' maturity, trustworthiness, and need for access. For example, dependent children of the owner may have access to a set aside portion of the funds in the financial account 114 by a parent (owner) via an alias. The children may only be permitted to withdraw a defined amount per month and restricted for specific purposes via the corresponding portal-defined attributes for the alias. An institution hosting one account 114 may be granted limited access to an account hosted by another institution (for example, access to an alias is used to transfer assets between the institutions).

In an embodiment, instead of requiring owners to perform cumbersome actions for inter-account operations, intra-institution operations, and inter-institution operations, attributes and attribute values can be assigned by the owner to automate these operations for typical, frequent, and recurring activities. For example, attributes may be set on a resource (account) that cause automatic operations to be performed for recurring bills, transfers between accounts, etc. As another example, a consumer (owner) may designate a direct deposit from an employer into a designated alias that has automated actions that cause one or more portions of each direct deposit to be further moved to a different alias account of the consumer and/or to an external account associated with a different financial institution.

In an embodiment of the previous embodiment, an institution hosting one account 114 may be granted limited access to an account hosted by another institution. For example, access to an alias may be used to transfer assets between the institutions.

In an embodiment, multiple separate accounts (separate resources) are maintained by cloud 110 and organized to cooperate as a single logical resource through metadata (links). Thus, cloud 110 may provide the features discussed herein for both a single resource that is associated with multiple aliases (one-to-many resources) or cloud 110 may provide the features for multiple resources that can be managed through links as a single logical resource (many-to-one resource).

In an embodiment, instead of limiting account 114 automation to basic operations (for example automatic transfers and overdraft protection within a same institution), sets of more complex automated operations (custom workflows) can be configured (via the rules assigned to the —attributes by resource manager 115) to have specific sets of actions processed by portal manager 116 when corresponding attribute values are detected (trigger events). For example, when a direct deposit is detected in account 114, the portal manager 116 matches the event associated with the deposit (internal account event) and obtains the assigned rules as a workflow that includes several actions. The actions defined by the rules are processed causing a predefined portion of the deposit to be transferred into an external account (investing or payment of an existing loan) using a specific resource service 133; another portion of the deposit can be transferred to an alias associated with account 114 using portal manager 116; and a current exchange rate between the U.S. dollar to a different currency type (e.g., Euro, cryptocurrency, etc.) is obtained as an external event from an exchange service (a type of resource service 133) such that when the exchange rate is below a owner-defined rate, portal manager 116 uses a third portion of the account 114 to purchase the different currency through the exchange service with the purchased currency being transferred to another alias of the account 114 or transferred to an external account of the owner held by the exchange service. This is but one example, workflows defined by the rules can include unrelated independent actions, interdependent actions, and/or a combination of both independent and interdependent actions. Moreover, the events that trigger processing of some of the rules can be internally generated events or externally acquired events.

In an embodiment, an alias can be defined with the appropriate set attributes and attribute values such that the alias supports receiving payments only, specifying withdrawal limits that can be disbursed per month or the frequency of disbursements (e.g., to pay monthly utility bills, etc.). Other aliases may have a specialized purpose, such as authorizing credit checks of the owners, performing a credit check, etc.

In an embodiment, account aliases and fund pools can be configured to prevent accidental or intentional revelation of an account alias to other parties ensuring that privacy is not compromised and ensuring the funds are not compromised. For example, an account alias is designated for deposits only or a pool of funds associated with the alias can be configured (via the attributes) to allow transfer of assets to only other pools of the account 114 (rather than to external parties).

In an embodiment, any pools of the funds from account 114 can be denominated in different types of currencies. Resource manager 115 can assign rules regarding currency conversion specified via the corresponding set of attributes and attribute values for each pool of funds and each alias of the account 114.

In an embodiment, access to a given pool of funds can be granted or restricted for each alias by the owner of account 114. For example, an account of $100 can have two aliases, one alias restricted to $20, and another alias restricted to $50. As another example, an account can have alias accounts set up that are restricted to types of currency, such as U.S. currency, Euro currency, crypto currency, etc. Further, an account can have alias accounts set up that are restricted to novel currency, such as store credits, points redeemable for merchandise or services (e.g., meals, air travel, etc.).

In an embodiment, a pool of funds can be designated for owner-determined purposes, such as Christmas, travel, collective expenses, goal purchases, etc. Thus, the owner may include aliases for different purposes/goals desired by the owner, each alias allocated a specific pool of funds (by type and/or by amount) and the owner can manage each purpose/goal separately via the aliases.

In an embodiment, inter-pool transfers of funds can be performed automatically by portal manager 116, when conditions detailed by the rules set on the attribute values are satisfied. For example, such transfers may include recurring transfers to external accounts, external parties, or to an alias account of the account 114.

In an embodiment, funds of the account 114 can be divided among pools to reduce risk of theft or fraud. For example, an alias may include a segmented portion of funds from account 114 where the alias identifier (portal identifier) is shared only with entities or services 130 that are allowed to withdraw funds from the segmented portion of funds. The entities or services 130 have no access rights to funds not designated by the configuration of the alias account.

In an embodiment, fund pools may be persistent or transient. For example, a transient pool of funds may be created for a one-time transaction involving currency that is not normally handled, with an assigned rule by resource manager 116 to disable or delete the corresponding account alias after allocated funds are removed (for example, a one-time earnest money deposit or down payment on a house to a mortgage company, etc.).

In an embodiment, an account 114 can have multiple different owners, each owner is granted different levels of access to use and/or configure the account and the aliases. Thus, an owner may allow a co-owner, via an alias account, to create other alias accounts that are restricted by funds and/or purpose. For example, an owner with a child may create an alias funded with a designated portion of the owner's account and allow that child to create aliases (sub aliases) of the alias for child-desired purposes, such as investing, entertainment, vacation, expenses, etc.

In an embodiment, some owners of a multi-owner account 114 may not have access to all of the aliases set on the account 114. For example, dependent children may only be allowed to access certain pools of funds.

In an embodiment, recurring activities, such as direct deposit to pay alias accounts can be automated via rules set by resource manager 116. For example, one account alias can be provided to the employer and the single designated alias can then distribute the received funds to other pools of funds designated by the owner.

In an embodiment, rules for automation can be set by resource manager 116 to automate inter-pool transfers and inter-account transfers to reduce any chance of human error. For example, one alias for investing may receive a set amount of monthly funds from the owner account 114 in a specific currency type. The alias may also send funds to other accounts owned by the owner such as a mortgage account where an owner's house payment is sent from the alias on a scheduled date of each month to a lender.

In an embodiment, the rules assigned to any given attribute and attribute value include conditions evaluated by portal manager 116 that notify the owner of certain types of activity with respect to a specified alias or fund pool. For example, an attempt is made to withdraw more funds than are permitted by the rules by a third party from an alias or a third party withdraws expected funds on a date that is not consistent with an expected date defined in the rules. Here, the notification can be a text message, an in-application (mobile application) message, email, etc. that is sent to the owner. The rules may also specify the manner or the channel (text, email, in-application message, etc.) that the notification message is to be sent to the owner. In an embodiment, conditions evaluated by portal manager 116 may require the owner to review and approve each month disbursement to a third party (e.g., owner-reviewed disbursements (e.g., monthly utility bill or mortgage payments)) before the disbursement is actual processed by portal manager 116.

Portal manager 116 can be triggered/initiated via APIs 117 from services 130. Portal manager 116 may also be triggered (initiated) to proactively perform operations based on detected events associated with the assigned rules (such as a time frequency, action performed on an alias or pool of funds, etc.). The detected events can be internal to a processing environment of the portal manager 116 or can be external to the processing environment. For example, portal manager 116 may identify an external event provided through resource service interface, obtained proactively by portal manager 116 through APIs 134 from a resource service 133, and/or proactively discovered by portal manager 116 by monitoring a resource service 133 (e.g., periodically querying, by portal manager 116 at defined intervals of time, a specific resource service 133 to obtain and monitor tracked external events defined in the rules).

In an embodiment, a novel service 133 is provided based on the data model for the account. This novel service 133 alters the traditional workflow associated with a payer making a payment to a payee for a transaction. In this embodiment, the owner has a designated public-facing alias for account 114 that is only capable of receiving payments and optionally a second alias designated for transferring payments (this can be the account 114 itself), which is private. Because the second alias is private, a criminal is unable to access the account, since the second alias identifier is never shared by the owner. Since portal manager 116 only permits receipts of deposits into the first alias, sharing the alias identifier presents no security risk to the owner. The payee shares a public-facing receipts-only alias with the payer along with the transaction details requesting payment for the transaction. The payer then sends the payer's private alias identifier and transaction details (transaction amount) along with the payee's public-facing alias identifier to novel service 133 (optionally with a small transaction fee for service 133). Service 133 uses APIs 134 to interact with APIs 117 associated with the payer's private alias account, portal manager 116 enforces any rules and authorizes the payment from the payer's private alias account to the payee's public-facing receipts-only alias account. Service 133 causes payment to payee's public-facing account 114 from payer's private-facing account 114. Service 133 sends a notification to payee and payer via text message, email, or within resource service interface 124.

In an embodiment, a novel service 133 is provided that does not require the parties to a transaction to exchange any information with one another except for a token or a transaction identifier (which can be scanned by a payer from a display as a Quick Response (QR) code that is encoded with the token or transaction identifier). Here, the payee submits a public-facing receipts-only account identifier to the service 133 along with the token/transaction identifier and transaction details while the payer submits a private disbursement account identifier to service 133 along with the token/transaction identifier. Service 133 links the payer to the payee based on the token/transaction identifier. Optionally, service 133 may request a confirmation from the payer and/or payee in performing the transaction after separately receiving the account identifiers from each of the parties. Service 133 moves the funds identified in the transaction details from the private disbursement account of the payer to the public-facing receipts only account of the payee to complete the transaction and sends confirmations back to both the payer and the payee. Optionally, transmissions between the parties to service 133 are encrypted, each party may use its own encryption in communicating with the service 133 (for example, public-private key pairs where the parties use their private keys and a public key of service 133 to encrypt their information for the transaction and service 133 utilizes a public key of the respective party along with its private key to decrypt the information).

In an embodiment, the parties exchange information between themselves with selective encryption to hide private account details of the parties. For example, a payer may provide a decrypted version of their financial institutions identifier and an encrypted version of the payer's private disbursement alias account identifier. The payee then sends the payer's encrypted private disbursement alias account identifier and the payee's public receipts-only alias account identifier to the bank using the non-encrypted plain text bank identifier provided by the payer. The bank is capable of decrypting the private disbursement alias account identifier to complete the transaction by moving funds from the payer's account to the receipts-only account of the payee. The encryption method used can be institution specific such as public-private key encryption; the payer encrypts the private account identifier with a public key of the bank and a a private key of the payer, the bank decrypts using the private key of the bank and a public key of the payer.

In an embodiment, a novel service 133 is provided to process solicited transactions (e.g., at checkout time of purchases). Payee provides a public-facing receipts-only account identifier (alias identifier), a transaction identifier, and a dollar amount due to a payer (customer). Payer provides a private disbursements account identifier (alias identifier), the payee account identifier, the transaction identifier, and the dollar amount to service 133 (optionally, a transaction fee required by service 133 is also provided by payer). Service 133 may engage a payment service 133 associated with payer or may directly engage portal manager 116 to cause payment in the dollar amount to be transferred from the payer's disbursement account 114 to payee's receipts-only account 114. Service 133 sends confirmation to payer and payee receives the funds and sends a separate confirmation to payer.

In an embodiment, a novel service 133 is provided to process unsolicited payment transactions (e.g., a gift or a donation). Payee provides payee account identifier (receipts only) to payer. Payer provides a private disbursements only account identifier (alias identifier) for payer, the payee account identifier, a transaction identifier, a dollar amount for the donation or gift, and optionally a transaction fee to service 133. Service 133 interacts with portal manager 116 or another payment service 133 associated with payer and the donation in the dollar amount are sent to payee's account 114. Service 133 accepts any transaction fee and sends a confirmation to payer. Payee acknowledges receipt of the donation/gift in the dollar amount to payer.

In an embodiment, a novel service 133 is provided to maintain a running tab by managing a hold on funds associated with a payer's account and ensuring sufficient funds are available to cover a final and closed out tab. The payee is a provider of goods or services while the payer is a consumer of those goods or services. Payee provides its public-facing account identifier (alias identifier) to the payer. Payer provides payer's private disbursal account identifier (alias identifier), payer's public-facing receipts-only alias account identifier, a hold identifier, a dollar limit, a time limit, and optionally a transaction fee to service 133. Service 133 interacts with portal manager 116 (via APIs 134 and 117), reserves funds from payer's account 114, and sends a notification to the payer and payee by providing the hold identifier, the dollar limit, the time limit, and respective account identifiers to each party (note: payee does not see payer's account identifier, but payer sees the payee's account identifier). Payee authorizes consumption of the goods or services by payer. Payer informs payee that consumption is complete or time limit for consumption expires. Payee provides the payee's public receipts-only account identifier, a transaction identifier, the hold identifier, and dollar amount due to payer. Payer provides payer's private disbursement account identifier, payee's public account identifier, the transaction identifier, the hold identifier, and the total amount due to service 133 (optionally, a service transaction fee is provided also). Service 133 transmits payment to payee account by sending payee account identifier, the hold identifier, the transaction identifier, and dollar amount due to portal manager 116 (or optionally a different payment service 133 associated with payer). The hold is released, and any fee provided accepted. A confirmation is sent to payer including the private account identifier of the payer, payee account identifier, the hold identifier, the transaction identifier, and the dollar amount. Payee receives confirmation of payment received and payee sends a confirmation to payer, including payee account, the hold identifier, the transaction identifier, and the dollar amount.

In an embodiment of the last embodiment, a series of running tab transactions, such as monthly utility bills or occasional on-demand usage of video content can be processed via service 133. Differences between a single tab scenario and a multiple tab scenario can be 1) the payee periodically bills the payer for incremental charges rather than just billing the payer for a final total as is the case in a single tab scenario; and 2) the payee may decline to place holds on the payer's account 114 for incrementally accrued charges in the series of tabs scenario. In either case (single tab or series of tabs), the payee never has access to the payer's private disbursement account identifier.

In an embodiment, a novel service 133 is provided to process a loan application/loan transaction. Here, the prospective borrower is referred to as applicant. The applicant sends a separately created private payer account identifier for a credit check, the lender's public account identifier, and a requested loan amount to service 133 as part of a request for generation of a credit check transaction identifier to portal manager 116. Portal manager 116 generates a single-use credit-check transaction identifier (alias account identifier) and sends it to applicant. The alias account is a single use alias that is specific for a credit check but since it includes account information of the applicant, the alias account may be created as a public or a private account by portal manager 116 based on the applicant's stated preference (which may be in a profile for the applicant, or which may be provided by the applicant with the request for generation of a credit check sent to portal manager 116). Applicant provides his public and/or private account identifier, the requested loan amount, and single-use credit check transaction identifier to lender. Lender sends its private disbursement account identifier, applicant's (payee) public and/or private account identifier, requested loan amount, and the single-use credit check transaction identifier to service 133 as part of a request for check of applicant's credit worthiness. Service 133 sends the single-use credit check transaction identifier, requested loan amount, and applicant's credit score (obtained through interaction with the single-use credit check transaction identifier from portal manager 116) to lender. Lender determines amount of loan and other terms of the loan, then sends the information to applicant. (Alternatively, lender declines to lend to applicant based on the determined credit score.) If applicant accepts terms of the loan, then applicant sends an acceptance message with the single-use credit check transaction identifier, amount of loan, and applicant's public-facing receipts only account identifier to lender. Lender sends loan transaction identifier, amount of loan, applicant's public account identifier, and lender's disbursements only private account identifier to service 133. Service 133 interacts with portal manager 116 to cause the loan amount to be transferred from the lender's private account to the applicant's public receipts only account. Service 133 sends confirmation with loan transaction identifier and amount of loan to applicant and lender. In an embodiment, the one-time credit check alias account may be created as a confidential account (a separate type from private or public), which portal manager 116 restricts access to for purposes of maintaining the credit check information privately with only a designated user (lender) being able (authorized) to access the alias account a single time for the credit check. Here, the applicant-provided request for generation of a credit check may specify a user-identifier of the lender so that portal manager 116 can verify that it is just the lender that accesses the alias account for a single credit check.

In an embodiment of the last embodiment, the applicant's alias credit check account for the loan application is designated as a restricted-sharable account that is neither fully private nor fully public. The lender attempting to access the restricted-sharable account must provide the alias account identifier that matches the temporary credit-check alias account, and the lender identifier must match the identifier provided by the applicant when creating the restricted-sharable account. Thus, two security checks are required for accessing a restricted-sharable account.

In an embodiment relevant to the last two referenced embodiments, the lender can establish a loan application identifier unique to the loan, such that the parties to the loan can separately send their information to service 133 and service 133 links the two together and grants the lender access to the restricted-sharable account when the lender has the correct lender identifier to access the account and when the lender identifies the loan with the correct loan application identifier. In this case, the restricted-sharable account identifier does not need to be supplied by applicant to the lender and from the lender to service 133 since the unique loan application identifier provides this linkage to service 133. In an embodiment, the lender may disburse the funds to the applicant via a temporary alias account that has access rules that limit the amount of currency that can be withdrawn by an applicant once a loan is approved.

In an embodiment, an owner of an account (resource 114) can be a consumer or an institution. The owner can utilize resource access interface 123 to define and create an alias for a gift card or donations through interaction with resource manager 115 as described above. A single alias for gift cards or donations may be further subdivided as many times as desired by the owner to create specific instances (via each sub alias) of the gift cards or donations. The gift cards are identified by the sub-alias identifiers distributed by the owner. The party receiving a given identifier is restricted by rules in the amount that can be used and, if desired by the owner, the allowed uses and/or disallowed uses (redemption restrictions, e.g., no alcohol, only travel, no further gifting to another party, etc.). For example, an institution may create a single alias for all gift cards sold by the institution, the alias can be further divided by the institution into sub aliases based on the value being sold ($50 gift cards, $100 gift cards, etc.), based on specific stores or regions, and/or based on both value sold and stores or regions. In another example, a consumer may create a single alias for donations, the alias can be further divided by consumer-defined organizations and/or types of organizations. This allows an institution to manage gift cards from a single alias account and a consumer to manage donations or gifts via a single alias account. The sub aliases can be hierarchical arranged and managed, for example a single first level alias for gift cards of an institution, a second level sub alias under the single alias by region, a third level sub alias under the second level by store, a fourth level sub alias under the third level by gift card amount, etc.

In an embodiment, portal manager 116 provides the ability to store and provide invoices that are set on attributes of the data model for a given resource 114. The invoices can be chained as a history for auditing and tracking by the owner or for dispute resolution between the owner and a given service provider. The invoice may be stored for any given transaction on the account 114. Furthermore, the invoices can be of any format and data size provided by a service provider. Portal manager 116 may also permit the owner to generate invoices from the provide invoices capability.

System 100 provides mechanisms by which private account details do not have to be exchanged for any transaction; rather, just public facing account identifiers are exchanged between the parties. Private account information is only shared with trusted services 130 and/or portal manager 116. As a result, “fraud insurance” can be substantially reduced for transactions and greater security is provided with the transactions. An account 114 can have many different aliases, each of which can have custom-defined access rules enforced by portal manager 116. Aliases can be further subdivided into sub aliases and the depth of the hierarchy can include multiple levels. For example, a retail business can establish separate account identities (aliases) for each of its store locations, each table within a single store, each waiter within a store, each checkout lane, each cashier, or each customer desk throughout the business. Furthermore, interface 123 provides a mechanism by which temporary aliases can be created, modified, and/or deleted with a temporary alias identifier after sharing the identifier with an untrusted party; persistent credit card numbers and financial accounts do not offer this flexibility.

System 100 provides a data model for resources 114. The data model provides extended features and capabilities for accessing the resources 114 including customized access and unique transaction workflows as discussed above. Portal manager 116 restricts access to the resources 114 based on assigned rules assigned by resource manager 115 in response to attributes and attribute values set on fields of the data model for the resources 114. Novel services 130 are further provided with system 100 to perform different types of transaction workflows as discussed above.

In an embodiment, cloud/server 110 is subsumed within a financial institution's server and provided as account service manager to customers of the financial institution. Here, 113-117 can be hosted by any given resource service server 130 associated with a corresponding resource service interface 124.

In an embodiment, a financial institution utilizes cloud/server 110 for account service management of its accounts. In this embodiment, interface 123 may be provided as an enhancement or an embedded service to an existing financial application of the financial institution via customer-operated devices 120 of the financial institution. That is, the resources 114 managed by the financial institution are hosted and managed via cloud 110.

In an embodiment, interface 123 is browser based such that interface 123 is delivered on device 120 through web pages hosted by cloud 110. Owner/user of resource 114 accesses resource 114 via any device 120 capable of processing a browser, such as a phone, a laptop, a desktop, etc.

In an embodiment, interface 123 is a mobile application download and processed on device 120. Here, device 120 is any device 120 capable of processing a mobile application, such as a phone, a laptop, a desktop, a wearable processing device, etc.

In an embodiment, predefined workflows for transactions associated with predefined resources 114 may entail a new service 133 that performs the workflows and enforces the access rules on behalf of or in place of portal manager 116. For example, in the example services 130 discussed above a payment clearinghouse service 133 may have direct access to the data model of resources 114 and enforce the access rules associated with resource access, such that portal manager 116 is subsumed into the service 133 for purposes of payment processing associated with resources 114.

In an embodiment, a new service 133 alters a traditional and existing workflow associated with payment processing as discussed above, however, one of the parties involved in the workflow does not subscribe to or utilize the data model associated with resources 114. In such embodiments, service 133 uses APIs 134 to interact with the traditional workflow for the payment service associated with the non-subscribing party.

In an embodiment, resources 114 can be associated with different types of enterprises beyond just financial institutions discussed in example embodiments of system 100. For example, a resource 114 may be a social media account 114 associated with a social media service. In this embodiment, the transactions are related to access requests for sharing different types of information associated with a given user (customer or user of the social media service). Any access to the private information of the user can be controlled through aliases (customized user-defined rules) and such access is further monitored and recorded by portal manager 116, such that privacy behavior can be audited for compliance with the service's stated privacy policy and/or required governmental regulations. It is to be noted that the data model for each type of information gathering service can be customized based on the type of information maintained and the transactions (along with the workflows) associated with accessing the information.

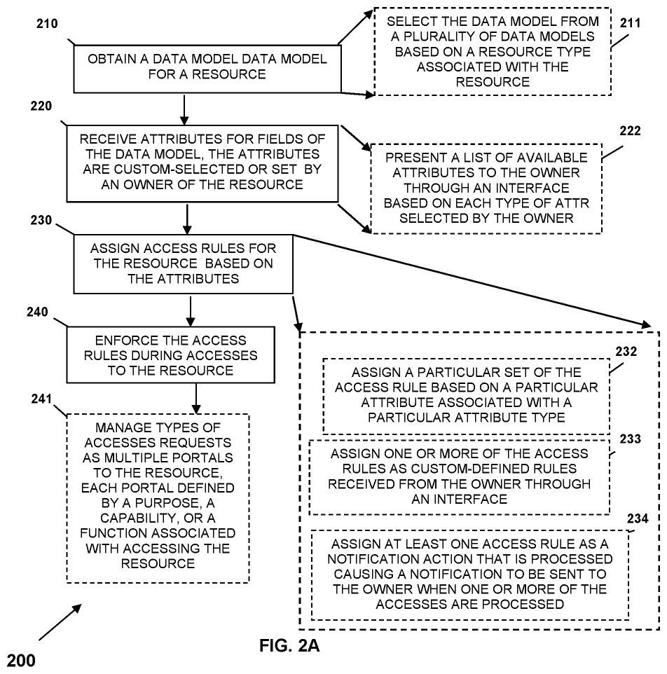

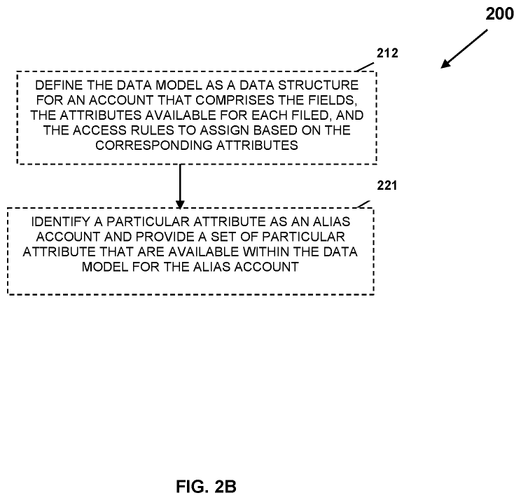

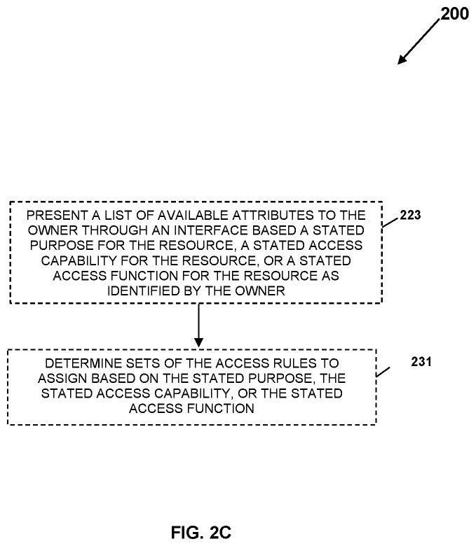

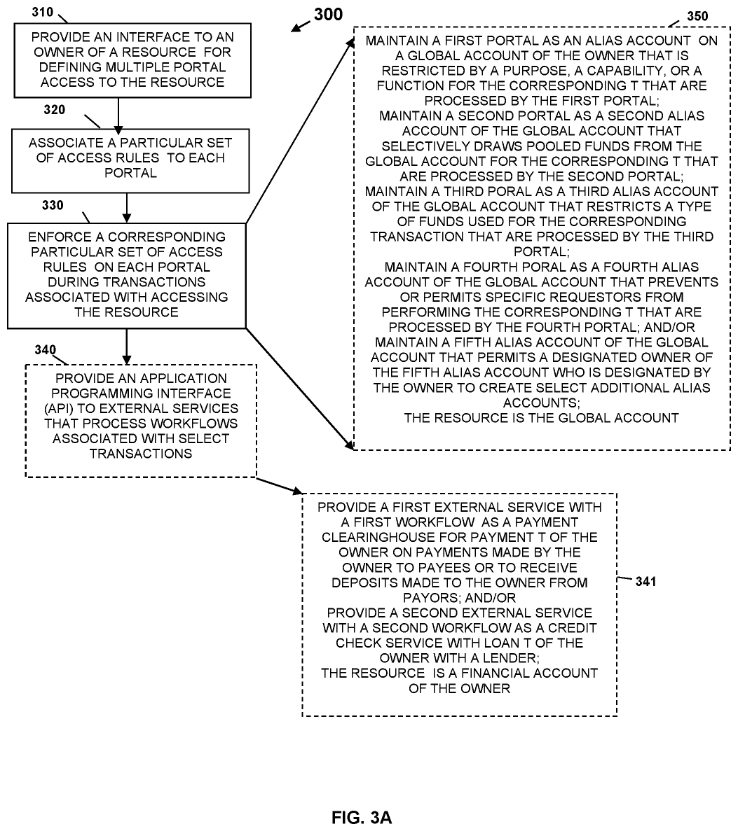

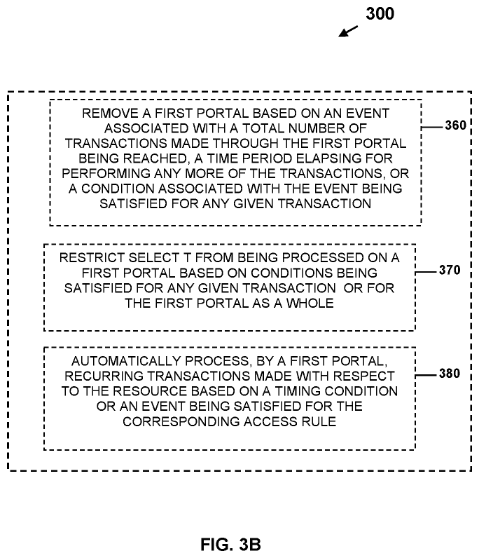

In an embodiment, devices 120 may include phones, tablets, wearable processing devices, laptop computers, Internet-of-Things (IoTs) devices, network-enabled voice devices (e.g., Google Home®, Amazon Echo®, etc.) specialized processor-enabled devices directed to accessing and providing information for the resources 114, specialized processor-enabled devices associated with one of the novel resource services 133, and/or desktop computers. The above-noted embodiments and other embodiments are now discussed with reference to FIGS. 2A, 2B, 2C, 3A, and 3B.

FIGS. 2A, 2B, and 2C are flow diagrams of a method 200 for resource modeling, access, and security processing, according to an example embodiment. The software module(s) that implement(s) the method 200 is referred to as a “resource manager.” The resource manager is implemented as executable instructions programmed and residing within memory and/or a non-transitory computer-readable (processor-readable) storage medium and executed by one or more processors of a device or set of devices. The processor(s) of the device(s) that execute(s) the resource manager are specifically configured and programmed to process the resource manager. The resource manager may have access to one or more network connections during its processing. The network connections can be wired, wireless, light-based translated to wireless, acoustic waves translated to wireless, or any combination of these network connections.

In an embodiment, the resource manager executes on server 110. In an embodiment, the server 110 is one of several servers logically presenting and cooperating as a single server representing a cloud 110 or a cloud processing environment 110. In an embodiment, the resource manager is one, all, or some combination of 113, 114, 115, 116, 117, 133, and/or 134.

At 210, resource manager obtains a data model for a resource. The data model may be derived for a specific enterprise, such as a financial enterprise, a social media enterprise, a retail enterprise, and other enterprises.

In an embodiment, at 211, the resource manager selects the data model from a plurality of data models based on a resource type associated with the resource. The types of resources can include a financial resource, a social media resource, or a service-based/product-based resource.

In an embodiment, at 212 (shown in FIG. 2B), the resource manager defines the data model or represents the data model as a data structure for an account (such as a financial account). The data structure includes fields, attributes available for each field, and access rules to assign based on the corresponding attributes or attribute values set on the fields.

At 220, the resource manager receives the attributes for fields of the data model. The attributes are custom-selected or set on the fields by an owner of the resource.

In an embodiment of 212 and 220, at 221 (shown in FIG. 2B), the resource manager identifies a particular attribute as an alias account and provides a set of particular attributes that are available within the data model for the alias account. That is, the resource is logically sub-divided within the data model as one or more aliases, each alias includes its own unique set of attributes.

In an embodiment, at 222, the resource manager presents a list of available attributes to the owner through an interface 123 based on each type of attribute selected by the owner through the interface 123. For example when an alias account is selected, resource manager presents categories by function of alias accounts available (receipts only, credit check only, donations only, etc.).

In an embodiment, at 223 (shown in FIG. 2C), the resource manager presents a list of available attributes to the owner through an interface 123 based on a stated purpose for the resource, a stated access capability for the resource, or a stated access function for the resource as identified by the owner. So, a selection by the owner of a receipts only alias account causes resource manager to present options (via the attributes) for receipts-only accounts.

At 230, the resource manager assigns access rules for the resource based on the attributes set on the fields of the data model. The attributes set on the fields determine the rules or sets of rules that are assigned.

In an embodiment of 223 and 230, at 231 (shown in FIG. 2C), the resource manager determines sets of the access rules to assign based on the stated access purpose, the stated access capability, or the stated access function. For example, an access rule will be assigned to an alias account that prohibits withdrawals when the stated capability or purpose of the corresponding alias is a receipts-only type of alias account.

In an embodiment, at 232, the resource manager assigns a particular set of the access rules based on a particular attribute associated with a particular attribute type. For example, a deposit-only assigned attribute is associated with a deposit-only attribute type, a credit-check assigned attribute is associated with a credit-check-only attribute type, etc.

In an embodiment, at 233, the resource manager assigns one or more of the access rules as custom-defined rules received from the owner through an interface. For example, the owner (through the interface) may list specific requestors that are permitted to access the resource and/or that are not permitted to access the resource; resource manager translates to custom-defined access rules.

In an embodiment, at 234, the resource manager assigns at least one access rule as a notification action that is to be processed causing a notification to be sent to the owner when one or more of the accesses are processed on the resource. The notification can be sent when an event is detected (an internal event generated by the processing environment of resource manager and/or an external event proactively discovered by resource manager from an external service 133). Additionally, in this embodiment, the access rules may include specific processing actions that are also to be processed on accesses made on the resource and/or detection of both internal and/or external events.

At 240, the resource manager enforces the access rules during accesses made to the resource. For example, each separately defined alias and its access rules can be managed as a separate defined portal to the resource enforced by resource manager (such as through portal manager 116).

In an embodiment, at 241, the resource manager manages types of access requests as multiple portals to the resource. Each portal may be defined by a purpose, a capability, or a function associated with accessing the resource.

FIGS. 3A and 3B are diagrams of a method 300 for resource modeling, access, and security processing, according to an example embodiment. The software module(s) that implement(s) the method 300 is referred to as a “resource portal manager.” The resource portal manager is implemented as executable instructions programmed and residing within memory and/or a non-transitory computer-readable (processor-readable) storage medium and executed by one or more processors of a device or set of devices. The processor(s) of the device that execute(s) the resource portal manager are specifically configured and programmed to process the resource portal manager. The resource portal manager may have access to one or more network connections during its processing. The network connections can be wired, wireless, or a combination of wired and wireless.

In an embodiment, the device that executes the resource portal manager is server 110 or cloud 110. In an embodiment, a first subset of resource portal manager executes on server/cloud 110 and one or more other subsets of resource portal manager executes on one or more resource servers 130. In an embodiment, the resource portal manager is all of, or some combination of, 113, 114, 115, 116, 117, 133, 134, and/or method 200. The resource portal manager presents another and, in some ways, an enhanced processing perspective from that which was described above for method 200 of FIG. 2.

At 310, resource portal manager provides an interface 123 to an owner of a resource for defining multiple portal access to the resource. Interface 123 is interactive, and each selection of attributes determine what options are next available for the owner to select.

At 320, the resource portal manager associates a particular set of access rules to each portal. An attribute associated with an alias having a defined purpose, capability, or function will be assigned a set of specific access rules for its corresponding portal.

At 330, the resource portal manager enforces a corresponding set of access rules on each portal during transactions associated with accessing the resource. The access rules are enforced for the corresponding portal during any attempt to access the resource.

In an embodiment, at 340, the resource portal manager provides an API 134 to external services 133 that process workflows associated with select transactions. This permits third-party services (such as clearing houses, payment services, etc.) to directly interact in a session in accordance with their workflows for accessing the resource via the appropriate portals.

In an embodiment of 340 and at 341, the resource portal manager provides a first external service 133 as a payment clearinghouse for payment transactions of the owner on payments made by the owner to payees or to receive deposits made to the owner from payers. Optionally or additionally, the resource portal manager provides a second external service 133 with a second workflow as a credit check service with loan transactions of the owner with a lender. The lender may provide a public portal that applicants can use to apply for loans by submitting applicant portal and other information to lender's portal. In these embodiments, the resource is a financial account of the owner.

In an embodiment, at 350, the resource portal manager maintains a first portal as an alias account on a global account of the owner that is restricted by purpose, a capability, or a function for the corresponding transactions that are processed by the first portal. Optionally or additionally, the resource portal manager maintains a second portal as a second alias account of the global account that selectively draws pooled funds from the global account for the corresponding transactions that are processed by the second portal. Optionally or additionally, the resource portal manager maintains a third portal as a third alias account of the global account that restricts a type of funds used for the corresponding transactions that are processed by the third portal. Optionally or additionally, the resource portal manager maintains a fourth alias account of the global account that prevents or permits specific requestors from performing the corresponding transactions that are processed by the fourth portal. Optionally or additionally, the resource portal manager maintains a fifth alias account that permits a delegated owner of the fifth alias account, who is designated/delegated by the owner, to create select additional alias accounts. In these non-exclusive or cumulative embodiments, the resource is the global account.

In an embodiment, at 360 (shown in FIG. 3B), the resource portal manager removes a first portal based on an event associated with a total number of transactions made through the first portal being reached, a time period elapsing for performing any more of the transactions, and/or a condition associated with the event being satisfied for any given transaction. This embodiment can be processed to provide a single-use portal, a portal limited to a specific number of transactions, a portal constrained by time, a portal constrained by time for a given period of time, a portal that restricts amounts of the resource by time period or by requestor, etc. (as was discussed above).

In an embodiment, at 370 (shown in FIG. 3B), the resource portal manager restricts select transactions from being processed on a first portal based on conditions being satisfied for any given transaction or for the first portal as a whole. For example, suppose a direct withdraw is limited in accordance with the rules to conditions that prohibit an amount that exceeds X, and an access request is X+1, this access request would be denied; an identifier from a requestor to access the resource is associated with a prohibited requester, such access requested would be denied; etc.

In an embodiment, at 380 (shown in FIG. 3B), the resource portal manager automatically processes, by a first portal, recurring transactions made with respect to the resource based on a time condition or an event being satisfied for the corresponding access rules. For example, transfer payment to an external service 130 payment for a utility bill; transfer a portion of a detected direct deposit into a different alias account or to an external investment account; etc.

It should be appreciated that where software is described in a particular form (such as a component or module) this is merely to aid understanding and is not intended to limit how software that implements those functions may be architected or structured. For example, modules are illustrated as separate modules, but may be implemented as homogenous code or as individual components. Some or all of these modules may be combined, or the functions may be implemented in software structured in any other convenient manner.

Furthermore, although the software modules are illustrated as executing on one piece of hardware, the software may be distributed over multiple processors or in any other convenient manner. Thus, the arrangement of the software as illustrated on specific hardware can be changed.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in fewer than all features of a single disclosed embodiment. Thus, the following claims are hereby incorporated into the Description of the Embodiments, with each claim standing on its own as a separate exemplary embodiment.

1. A method, comprising:
obtaining a data model for a resource;
receiving attributes for fields of the data model, wherein the attributes are custom-selected or custom set for the fields by an owner of the resource;
assigning access rules for the resource based on the attributes; and
enforcing the access rules during accesses to the resource.

2. The method of claim 1, wherein obtaining further includes selecting the data model from a plurality of data models based on a resource type associated with the resource.

3. The method of claim 1, wherein obtaining further includes defining the data model as a data structure for an account that comprises the fields, the attributes available for each field, and the access rules to assign based on the corresponding attributes.

4. The method of claim 3, wherein receiving further includes identifying a particular attribute as an alias account and providing a set of particular attributes that are available within the data model for the alias account.

5. The method of claim 1, wherein receiving further includes presenting a list of available attributes to the owner through an interface based on each type of attribute selected by the owner.

6. The method of claim 1, wherein receiving further includes presenting a list of available attributes to the owner through an interface based on a stated purpose for the resource, a stated access capability for the resource, or a stated access function for the resource identified by the owner.

7. The method of claim 6, wherein assigning further includes determining sets of the access rules to assign based on the stated purpose, the stated access capability, or the stated access function.

8. The method of claim 1, wherein assigning further includes assigning a particular set of the access rules based on a particular attribute associated with a particular type of attribute.

9. The method of claim 1, wherein assigning further includes assigning one or more of the access rules as custom-defined rules received from the owner through an interface.

10. The method of claim 1, wherein assigning further includes assigning at least one access rule as a notification action that is processed causing one or more of:
a notification to be sent to the owner when one or more of the accesses are processed;
the notification to be sent to the owner when an external event associated with an external service is obtained; and
an action or a workflow associated with a set of actions to be processed based on detection of internal event associated with the resource or based on detection of the external event associated the external service.

11. The method of claim 1, wherein enforcing further includes managing types of access requests as multiple portals to the resource, each portal defined by a purpose, a capability, or a function associated with accessing the resource.

12. A method, comprising:
providing an interface to an owner of a resource for defining multi-portal access to the resource;
associating a respective set of access rules to each portal based on attributes assigned to the resource by the owner through the interface; and
enforcing the respective set of access rules on each portal during transactions associated with accessing the resource.

13. The method of claim 12 further comprising, providing an Application Programming Interface (API) to external services that process workflows associated with select transactions.

14. The method of claim 13 further comprising:
providing a first external service with a first workflow as a payment clearinghouse for payment transactions of the owner for payments made by the owner to payees or to receive as deposits made to the owner from payers; or
providing a second external service with a second workflow as a credit check service associated with loan transactions of the owner with a lender;
wherein the resource is a financial account of the owner.

15. The method of claim 12 further comprising:
maintaining a first portal as an alias account on a global account of the owner that is restricted by a purpose, a capability, or a function for the corresponding transactions that are processed by the first portal;
maintaining a second portal as a second alias account on the global account that selectively draws pooled funds from the global account for the corresponding transactions that are processed by the second portal;
maintaining a third portal as a third alias account on the global account that restricts a type of funds used for the corresponding transactions that are processed by the third portal;
maintaining a fourth portal as a fourth alias account on the global account that prevents or permits specific requestors from performing the corresponding transactions that are processed by the fourth portal; or
maintaining a fifth portal as a fifth alias account on the global account that permits a delegated owner of the fifth alias account who is designated by the owner to create select additional alias accounts;
wherein the resource is the global account.

16. The method of claim 12 further comprising, removing a first portal based on an event associated with a total number of the transactions made through the first portal being reached, a time period elapsing for performing any more of the transactions, or a condition associated with the event being satisfied for any given transaction.

17. The method of claim 12 further comprising, restricting select transactions from being processed on a first portal based on conditions being satisfied for any given transaction or for the first portal as a whole.

18. The method of claim 12 further comprising, automatically processing, by a first portal, recurring transactions made with respect to the resource based on a timing condition or an event being satisfied for the corresponding access rules.

19. A system, comprising:
a server comprising at least one processor and a non-transitory computer-readable storage medium,
wherein the non-transitory computer-readable storage medium comprises server executable instructions, and
wherein the server executable instructions, when executed by the at least one processor, cause the at least one processor to perform operations comprising:
maintaining a data model for a resource, attributes set on the resource by the owner, and access rules for transactions on the resource based on the attributes;
defining portals for performing the transactions based on the corresponding access rules; and
processing the corresponding transactions and enforcing the corresponding access rules through the portals to provide customized portal access to the resource based on capabilities, functions, or purposes associated with each transaction.

20. The system of claim 19, wherein the server executable instructions when executed by the at least one processor from the non-transitory computer-readable storage medium further cause the at least one processor to perform additional operations comprising:
providing an interface to the owner for setting the attributes and assigning at least a portion of the access rules as owner-defined custom access rules.
